(19) United States
(12) Patent Application Publication
(10) Pub. No.: US 2004/0050110 A1
(43) Pub. Date: Mar. 18, 2004

(54) Methods for fabricating optical fibers and optical fiber preforms

(76) Inventors: George E. Berkey, Pine City, NY (US); Dennis W. Buckley, Dundee, NY (US); Michael T. Gallagher, Corning, NY (US); Daniel W. Hawtof, Corning, NY (US); Carlton M. Truesdale, Corning, NY (US); Natesan Venkataraman, Corning, NY (US)

Correspondence Address: CORNING INCORPORATED, SP-TI-3-1, CORNING, NY, 14831

(21) Appl. No.: 10/232,099

(22) Filed: Aug. 29, 2002

(51) Int. Cl. C03B 37/075

(52) U.S. Cl. 65/393; 65/395; 65/414; 65/421; 65/428

(57) ABSTRACT

The present invention provides methods for fabricating optical fiber preforms and optical fibers. According to one embodiment of the invention, a method for making an optical fiber preform includes the steps of providing at least one sacrificial rod having an outside surface; forming a material on the outside surface of each sacrificial rod to yield a structured body, the structured body including a structured material in substantial contact with the at least one sacrificial rod; removing each sacrificial rod from the structured body; and including the structured body in the optical fiber preform. The preform may be drawn into an optical fiber. The methods of the present invention are especially useful in the fabrication of microstructured optical fibers.

### BACKGROUND OF THE INVENTION

1. Field of the Invention

The present invention relates generally to optical fibers, and more specifically to methods for the fabrication of optical fibers and optical fiber preforms.

2. Technical Background

Optical fibers formed completely from glass materials have been in commercial use for more than two decades. Although such optical fibers have represented a leap forward in the field of telecommunications, work on alternative optical fiber designs continues. One promising type of alternative optical fiber is a microstructured optical fiber, which includes holes or voids running longitudinally along the fiber axis. The holes generally contain air or an inert gas, but may also contain other materials.

Microstructured optical fibers may be designed to have a wide variety of properties, and may be used in a wide variety of applications. For example, microstructured optical fibers having a solid glass core and a plurality of holes disposed in the cladding region around the core have been constructed. The arrangement, spacings and sizes of the holes may be designed to yield microstructured optical fibers with dispersions ranging anywhere from large negative values to large positive values. Such fibers may be useful, for example, in dispersion compensation. Solid-core microstructured optical fibers may also be designed to be single mode over a wide range of wavelengths. Solid-core microstructured optical fibers generally guide light by a total internal reflection mechanism; the low index of the holes can be thought of as lowering the effective index of the cladding region in which they are disposed.

One especially interesting type of microstructured optical fiber is the photonic band gap fiber. Photonic band gap fibers guide light by a mechanism that is fundamentally different from the total internal reflection mechanism. Photonic band gap fibers have a photonic crystal structure formed in the cladding of the fiber. The photonic crystal structure is a periodic array of holes having a spacing on the order of the wavelength of light. The core of the fiber is formed by a defect in the photonic crystal structure cladding. For example, the defect may be a hole of a substantially different size and/or shape than the holes of the photonic crystal structure. The photonic crystal structure has a range of frequencies, known as the band gap, for which light is forbidden to propagate in the photonic crystal structure. Light introduced into the core of the fiber having a frequency within the band gap will not propagate in the photonic crystal cladding, and will therefore be confined to the core. A photonic band gap fiber may have a core that is formed from a hole larger than those of the surrounding photonic crystal structure; in such a hollow-core fiber, the light may be guided in a gaseous medium, lowering losses due to absorption and Rayleigh scattering of glass materials. As the light is guided in a gaseous medium, hollow-core fiber may also have extremely low nonlinearity.

Microstructured optical fibers are fabricated using methods roughly analogous to the manufacture of all-glass optical fiber. A structured preform having the desired arrangement of holes is formed, then drawn into fiber using heat and tension. In both the preform fabrication and the fiber drawing processes, the size, shape, and arrangement of the holes may be significantly distorted due to the softness of the material and surface tension inside the holes. Such distortions may be especially damaging in hollow-core photonic band gap fiber, as the band gap may be quite sensitive to variations in characteristic dimensions of the photonic crystal structure such as hole size, pitch (distance between neighboring holes) and symmetry.

Structured optical fiber preforms are conventionally made by stacking glass rods and hollow glass capillaries to form a bundle, sleeving the bundle within a tube, and drawing the sleeved bundle to form a preform, which is subsequently subjected to further reduction in size to yield an optical fiber. In the drawing process, it is necessary to eradicate any unwanted void space (e.g., the interstitial voids between the rods and/or tubes), while not collapsing the desired structural voids. Extra process steps are often necessary to completely remove the interstitial voids, which would otherwise remain to adversely effect the optical performance of the microstructured optical fiber.

### SUMMARY OF THE INVENTION

One aspect of the present invention relates to a method of making an optical fiber preform having a core region and a cladding region, the method including the steps of providing at least one sacrificial rod having an outside surface; forming a material on the outside surface of each sacrificial rod to yield a structured body, the structured body including a structured material in substantial contact with the at least one sacrificial rod; removing each sacrificial rod from the structured body; and including the structured body in the optical fiber preform.

Another aspect of the present invention relates to a method of making an optical fiber including the steps of providing at least one sacrificial rod having an outside surface; forming a material on the outside surface of each sacrificial rod to yield a structured body, the structured body including a structured material in substantial contact with the at least one sacrificial rod; removing each sacrificial rod from the structured body; including the structured body in an optical fiber preform; and drawing the optical fiber preform into the optical fiber.

Another aspect of the present invention relates to a method of making optical fiber preform having a core region and a cladding region, the method comprising the steps of providing a plurality of elongate elements, each elongate element having an outside surface, the elongate elements being held in a fixed spatial relationship; forming a soot on the outside surface of each elongate element, substantially filling the spaces between the elongate elements to form a structured body; consolidating the soot to form a structured material; and including the structured body in the optical fiber preform.

The methods and optical fibers of the present invention result in a number of advantages over prior art methods and optical fibers. For example, the methods of the present invention enable the construction of structured optical fiber preforms having a wide variety of structural arrangements and cross-sectional shapes. The methods of the present invention also allow for substantially complete removal of interstitial void space in structured optical fiber preforms. The methods of the present invention further allow for the fabrication of preforms for optical fibers having substantially acircular core geometries. The methods of the present invention also enable the fabrication of optical fibers having a minimal number of glass-glass interface-related defects. Further, the use of soot laydown or vapor deposition techniques allow for the fabrication of preforms having relatively low amounts of contaminants.

Additional features and advantages of the invention will be set forth in the detailed description which follows, and in part will be readily apparent to those skilled in the art from the description or recognized by practicing the invention as described in the written description and claims hereof, as well as in the appended drawings.

It is to be understood that both the foregoing general description and the following detailed description are merely exemplary of the invention, and are intended to provide an overview or framework to understanding the nature and character of the invention as it is claimed.

The accompanying drawings are included to provide a further understanding of the invention, and are incorporated in and constitute a part of this specification. The drawings are not necessarily to scale. The drawings illustrate one or more embodiment(s) of the invention, and together with the description serve to explain the principles and operation of the invention.

### BRIEF DESCRIPTION OF THE DRAWINGS

FIG. 1 is a perspective schematic view of a method for making a structured optical fiber preform according to one embodiment of the present invention;

FIG. 2 is a perspective schematic view of a method for making a structured optical fiber preform using a casting technique according to an embodiment of the present invention;

FIG. 3 is a cross-sectional schematic view of a method for making a structured optical fiber preform using a tube collapse technique according to an embodiment of the present invention;

FIG. 4 is a cross-sectional schematic view of a method for making a structured optical fiber preform using interstitial rods according to an embodiment of the present invention;

FIG. 5 is a cross-sectional schematic view of a method for making a photonic band gap optical fiber preform according to an embodiment of the present invention;

FIG. 6 is a cross-sectional schematic view of a method for making a photonic band gap optical fiber preform using a tube collapse method according to an embodiment of the present invention;

FIG. 7 is a partial cross-sectional schematic view of a tube/rod assembly having interstitial rods;

FIG. 8 is a cross-sectional view of a stack-and-draw method for making a photonic band gap optical fiber preform according to an embodiment of the present invention;

FIG. 9 is a cross-sectional view of a stack-and-draw method using sacrificial rods in the stacked tubes according to an embodiment of the present invention;

FIG. 10 is a cross-sectional view of a method for making an anisotropic-core optical fiber preform according to an embodiment of the present invention;

FIG. 11 is a cross-sectional view of a method for making a mode converter optical fiber preform according to an embodiment of the present invention;

FIG. 12 is a cross-sectional view of a mode converter optical fiber according to an embodiment of the present invention;

FIG. 13 is a perspective view of initial steps of a method for making a structured optical fiber preform according to an embodiment of the present invention; and

FIG. 14 is a cross-sectional view of final steps of a method for making a structured optical fiber preform according to an embodiment of the present invention.

### DETAILED DESCRIPTION OF THE PREFERRED EMBODIMENTS

One aspect of the present invention includes a method for fabricating an optical fiber preform. The method includes the steps of providing at least one sacrificial rod having an outside surface, forming a material on the outside surface of each sacrificial rod to yield a structured body, removing each sacrificial rod from the structured body, and including the body in the optical fiber preform. Preforms fabricated using the methods of the present invention may be used to make structured optical fiber having structural elements of a desired size, shape, and arrangement, and having substantially no glass-glass interface related defects.

As used herein, a sacrificial rod is an elongate member that is used as a template in the formation of a structured body, and is removed, or at least substantially removed before the preform is drawn into an optical fiber. The sacrificial rod can be used as a template for the formation of a structural element (e.g. a hole) of the structured body. For example, a single sacrificial rod machined to have a complex cross-sectional shape may be used to make a structured body having a hole with the complex cross-sectional shape. For example, the sacrificial rod may have a substantially acircular cross-section. Alternatively, a plurality of sacrificial rods may be held in a fixed spatial relationship, and may be used to form a structured body having a plurality of holes having the fixed spatial relationship. The skilled artisan will recognize that a plurality of sacrificial rods held in a fixed spatial relationship, each rod having a desired cross-sectional shape, may be used to form a structured body having a wide variety of desired structural patterns.

The structured bodies of the present invention may have a substantially circularly asymmetric cross-sectional arrangement of structural elements. As used herein, a circularly asymmetric cross-sectional arrangement has substantially no C_{∞}rotational axes.

The sacrificial rod is suitably formed from a material that can be removed from the structured body physically and/or chemically, leaving substantially no residue in the optical fiber preform. For example, if the sacrificial rod does not adhere strongly to the structured body, the sacrificial rod may be physically removed by pulling or pushing the sacrificial rod out of the structured body. Chemical removal techniques include, for example, oxidation (e.g. burning out) of the material of the sacrificial rod; and chemical etching of the material of the sacrificial rod. Especially suitable materials for the sacrificial rod are those that may be removed both physically and chemically. When using these materials, the bulk of the sacrificial rod may be removed by pulling the rod out of the structured body. Any residual sacrificial rod material may then be removed chemically (e.g. by oxidation).

An especially suitable material for the formation of the rod is graphite. Graphite rods may be removed from many glass materials by pulling, and can be removed by oxidation in air or oxygen at temperatures above 700° C. Graphite can be machined or extruded using known techniques to yield sacrificial rods having well-controlled cross-sectional shapes and sizes. Other suitable materials for the formation of structured rods may include, for example, metals, ceramics, and polymeric materials.

The spacing of a plurality of sacrificial rods may be controlled by a holding apparatus suitably configured to hold the rods in a fixed spatial relationship. The holding apparatus may hold the sacrificial rods at one or both ends. The holding apparatus may be, for example, a glass or silicon substrate with receptacles formed therein to receive the ends of the sacrificial rods. Alternatively, a precision-machined part may be fabricated to act as the holding apparatus. The skilled artisan will appreciate that many other holding apparati may be used in the methods of the present invention.

A variety of materials and techniques may be used by the skilled artisan in the formation of the material on the outside surface of the sacrificial rods to yield the structured body. Materials such as undoped silica glass; doped silica glass; other inorganic glass materials such as borosilicate, aluminosilicate, and chalcogenide glasses; organic-inorganic hybrid materials; and polymeric materials may be suitably used as the material of the structured body. Techniques such as flame hydrolysis laydown, chemical vapor deposition processes, sol-gel processing, melt casting, and cast-and-cure processing may be used in the formation of the structured body. In another suitable technique, an already-formed glass soot is cast into a mold containing pre-arranged sacrificial rods and sintered. Another suitable technique is vacuum-assisted tube collapse, in which a tube of a material is first placed around one or more sacrificial rods. A vacuum is pulled on the inside of the tube, and the tube is heated to collapse it around the sacrificial rod(s). Other materials and processes may be adapted for use in the methods of the present invention by the skilled artisan. As the skilled artisan will appreciate, the type of material used to form the structured body will strongly influence the selection of the material of the sacrificial rods.

It may be desirable to perform the step of forming the microstructured material under conditions that will not damage the sacrificial rod(s). For example, the forming step may be performed in an inert or reducing atmosphere to prevent the oxidation of the sacrificial rod(s). The material of the rods may also be chosen to be stable to the temperatures reached in the forming step.

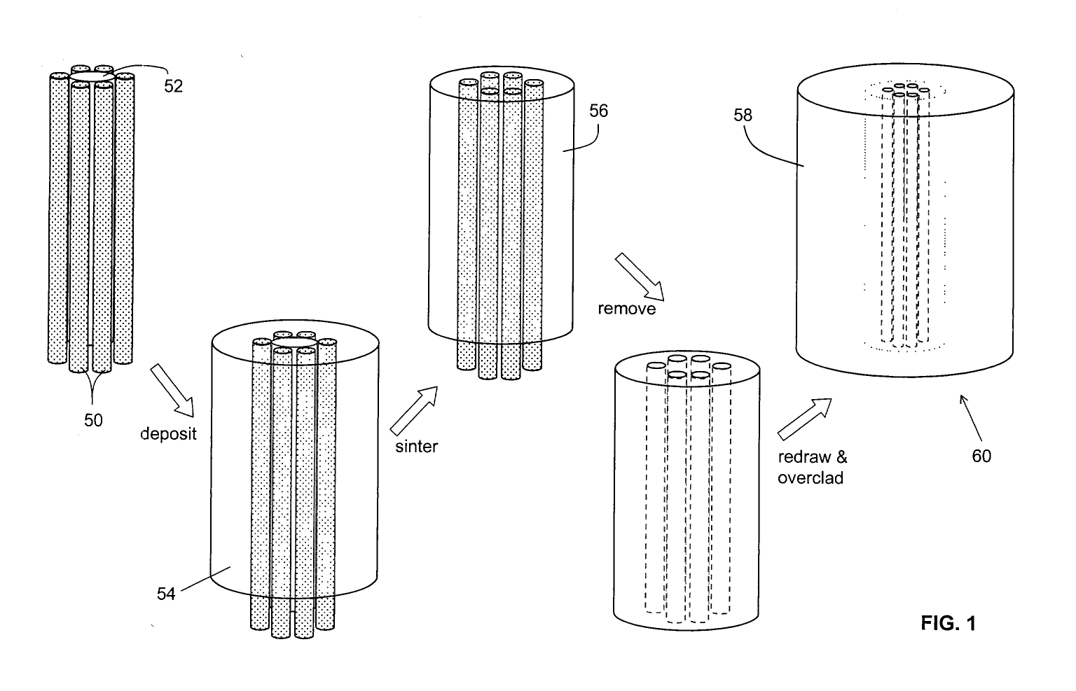

An exemplary embodiment of the present invention is shown in cross-sectional view in FIG. 1. Sacrificial rods 50 are fixed in place around core rod 52. Core rod 52 will form the core of the optical fiber fabricated from the preform, and is formed from a material suitable for such use (e.g. doped or undoped silica glass). The sacrificial rods and the core rod may be held in a fixed spatial relationship, for example, by a holding apparatus (not shown) at at least one end of the rods. The relative size and placement of the core rod and sacrificial rods may be chosen by the skilled artisan to yield the desired preform geometry. The sacrificial rods/core rod assembly is coupled to a VAD or OVD lathe, and a soot 54 of a material suitable for use as the structured material (e.g. doped or undoped silica) is deposited around the outside of the assembly. The soot 54 is sintered using methods familiar to the skilled artisan to yield a structured body 56. The sacrificial rods are then removed from the structured body by physical and/or chemical methods. The soot may be sintered in an inert or reducing atmosphere in order to prevent chemical removal of the sacrificial rods during the sintering step. Alternatively, the step of removing the sacrificial rods may occur during the step of sintering the soot, for example, by performing the sintering in an oxidizing atmosphere. The structured body is redrawn and overclad with an overclad material 58 to yield a complete optical fiber preform 60, which may then be drawn into an optical fiber. It may be desirable for the overclad material to have a softening point of at least about 50° C. less than the softening point of the structured material, as described in U.S. patent application Ser. No. 10/171,337, which is incorporated herein by reference. Such a softening point relationship may allow the overclad material to be processed (e.g. consolidated) without substantially affecting the geometry of the structured body. For example, the structured material may be fluorine-doped silica, and the overclad material may be boron-doped silica. Variations of the preform 60 may be used, for example, for fabricating dispersion-compensating microstructured optical fibers.

In the embodiment of the invention described in connection with FIG. 1, the core of the preform is formed by core rod 52. Alternatively, the core rod 52 may be omitted, and the soot 54 may be used to form the core of the preform. Use of the soot in the formation of the core of the preform will yield a structured body formed from a substantially homogeneous material, and may be suitable in cases where glass-glass interfaces are especially undesirable.

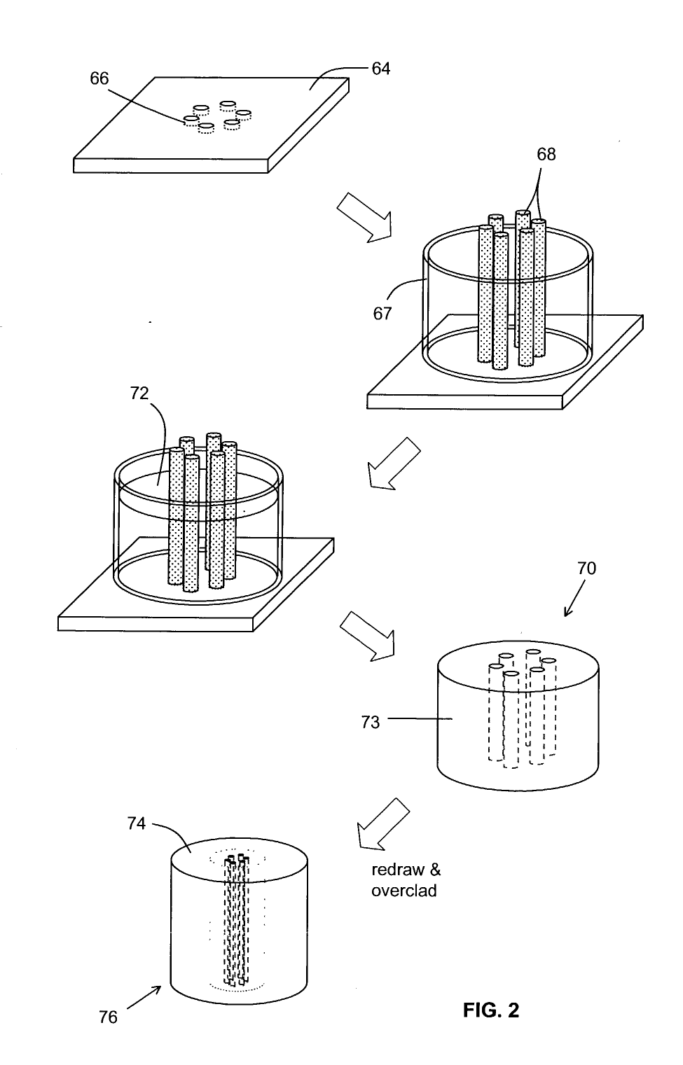

In another embodiment of the invention, shown in perspective view in FIG. 2, a sol-gel process is used to form the structured material. A glass plate 64 with receptacles 66 for the sacrificial rods is provided and acts as a holding apparatus for the sacrificial rods. The sacrificial rods 68 are inserted into the receptacles 66, and affixed to the glass plate 64, thereby being held in a fixed spatial relationship. A tubular jacket 67 is affixed to the glass plate 64, thereby forming a cylindrical container with the sacrificial rods 68 inside. A sol is poured into the container formed by the jacket 67 and the plate 64, and is allowed to gel, forming gel 72. Suitable sol-gel materials and processes may be selected by the skilled artisan. For example, suitable materials and processes are described in U.S. Pat. No. 6,209,357, which is incorporated herein by reference. After the gel 72 is formed, the jacket 67 and the glass plate 64 are removed. In succeeding steps, the sacrificial rods 68 are removed, and the gel is fired to remove any residual porosity, yielding structured body 70 formed from structured material 73. The sacrificial rods may be removed physically before or after the firing step, or chemically during or after the firing step. The structured body 70 may be sleeved by an overclad tube 74, and redrawn to yield preform 76, using methods familiar to the skilled artisan. As described above, it may be desirable for the material of the overclad tube to have a softening point of at least about 50° C. less than the softening point of the structured material. While in the embodiment described above, the gel 72 is removed from the jacket 67, the present invention also includes a process in which the gel 72 remains in jacket 67, which becomes part of the cladding of the eventual optical fiber.

In the embodiment described above in connection with FIG. 2, the structured body 70 is fabricated by casting a sol-gel derived material into a mold formed by jacket 67, glass plate 64, and sacrificial rods 68. This casting technique may be used with other suitable material systems. For example, a molten glass may be cast into the mold, and allowed to cool, thereby forming the structured body. Low-melting glasses such as chalcogenide glasses are especially suitable for processing in this manner. In another exemplary embodiment of the present invention, a curable polymer composition may be cast into the mold and cured to yield a polymeric structured body. In another embodiment of the invention, a siliceous soot, made for example by a flame hydrolysis technique, is packed or poured into the mold and sintered to yield the structured body. In each of these techniques, the skilled artisan may determine the timing and method of removal of the structured body from the mold.

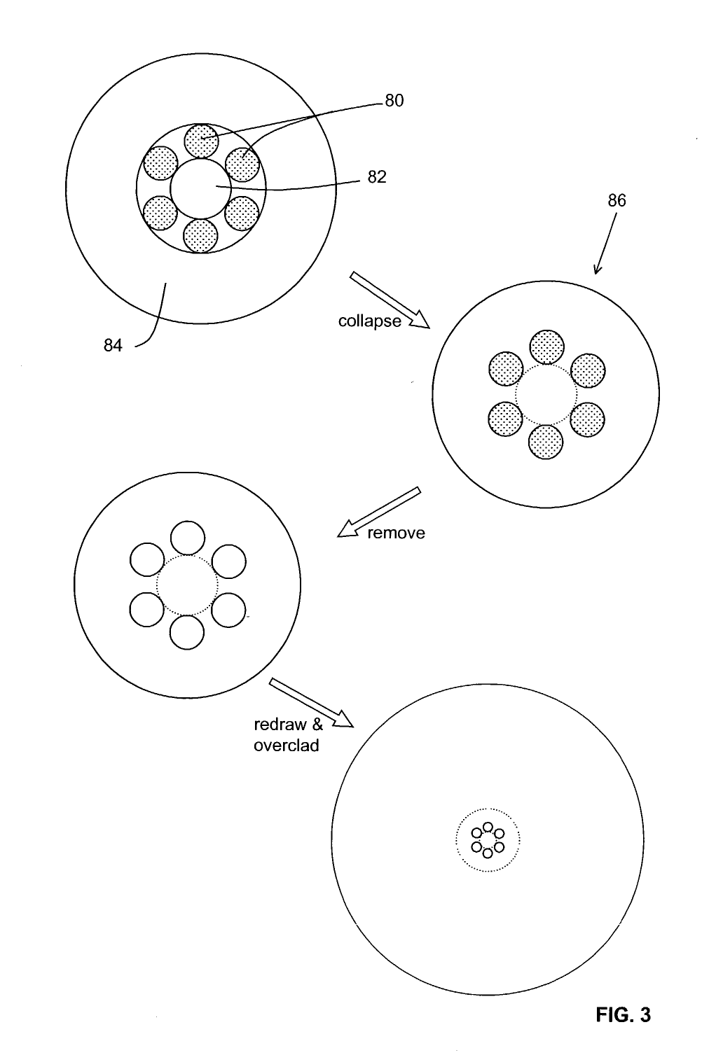

FIG. 3 illustrates another exemplary method of the present invention in cross-sectional view. A set of sacrificial rods 80 are held in a fixed relationship between core rod 82 and cladding tube 84. The core rod 82 and the cladding tube 84 may be made from the same material (e.g. doped or undoped silica glass). Alternatively, the cladding tube 84 may have a slightly lower refractive index at a wavelength of interest than the core rod 82, so that the material of the cladding tube 84 functions as a cladding material for the material of the core rod 82. A vacuum is applied to the region between the core rod and the cladding material, and heat is applied to the assembly in order to collapse the cladding tube 84 around the sacrificial rods 80, forming structured body 86. The use of the sacrificial rods allows the step of collapsing the tube to be performed under conditions of relatively high heat and vacuum. Deformation of the structure is not a primary concern in this step, as the material of the sacrificial rods acts to define the structure, and is chosen to be stable to the collapse conditions. As such, the collapse conditions may be chosen to ensure complete collapse of the structured body. After collapse, the sacrificial rods may be removed by physical and/or chemical methods (for example, by burning out the sacrificial rods in an oxidizing atmosphere), and the structured body may be overclad, for example, by soot deposition or sleeving with a cladding tube.

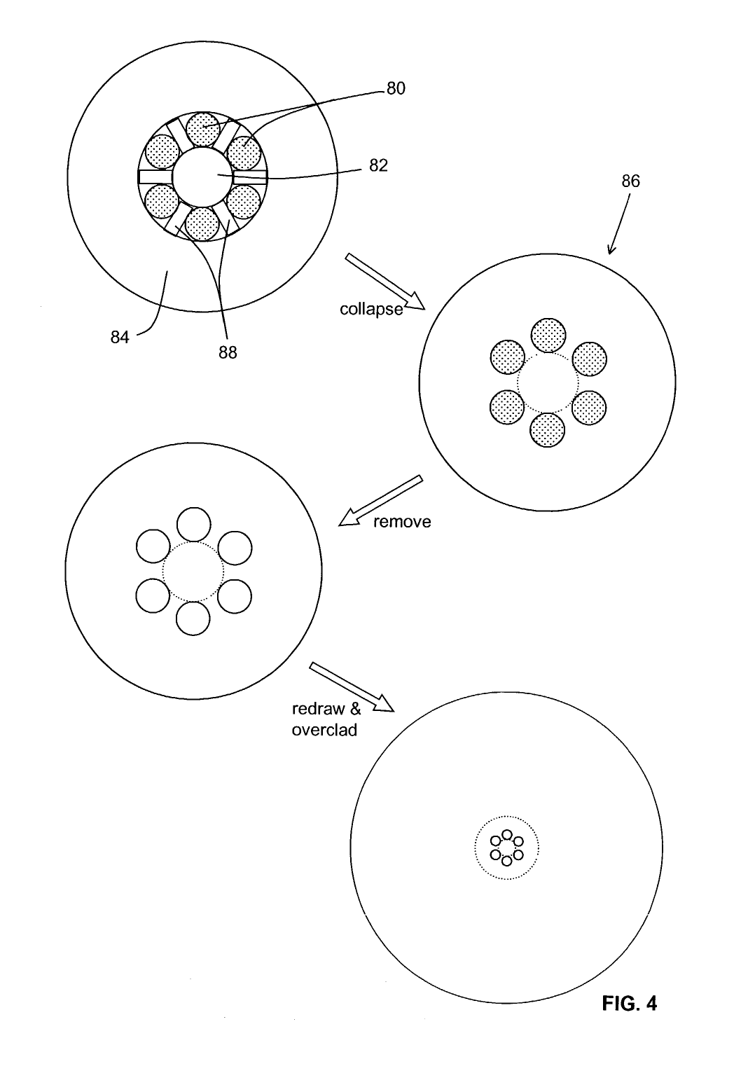

In another embodiment of the present invention, shown in cross-sectional view in FIG. 4, interstitial rods 88 may be provided in the region between the core rod 82 and the cladding tube 84. The method described above in connection with FIG. 3 may be used to construct the optical fiber preform of FIG. 4. In this embodiment of the invention, the interstitial rods 88 are formed from the material of the core rod and/or the cladding tube, and provide some of the material near the sacrificial rods 80. This embodiment may be advantageous, as less material from the cladding tube 84 needs to flow into the region between the core rod and the cladding tube.

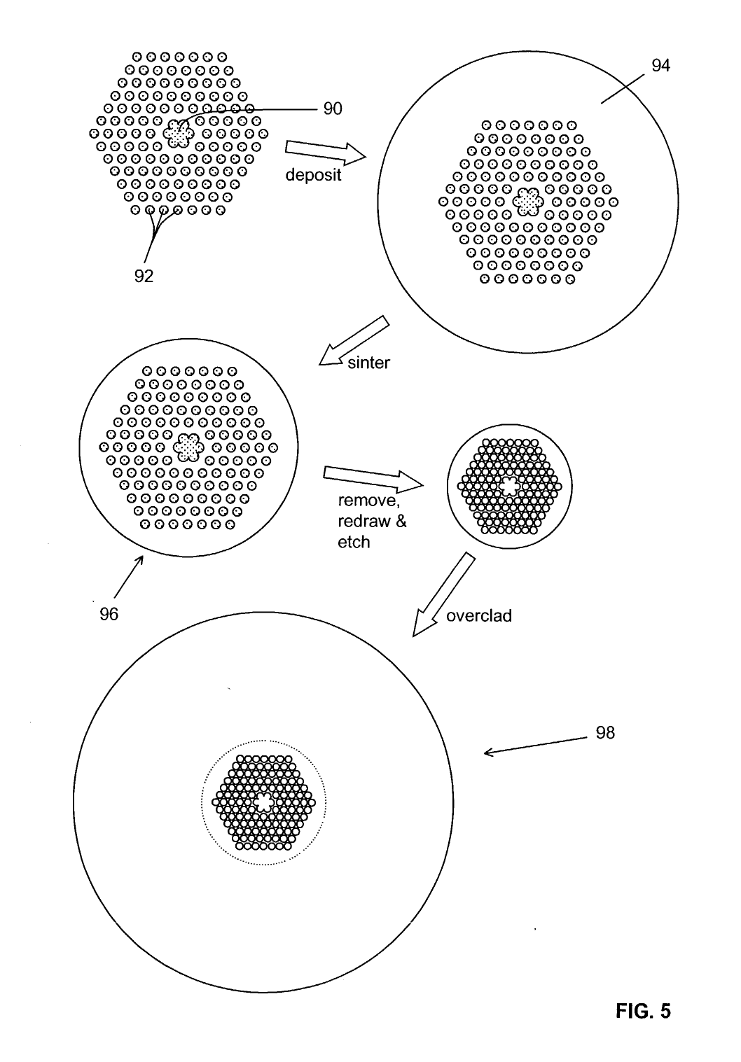

While the invention has been described above with respect to a structured body having a single ring of holes, the skilled artisan will appreciate that virtually any desired structural arrangement may be achieved using the methods of the present invention. For example, as shown in cross-sectional view in FIG. 5, a preform suitable for the fabrication of a photonic band gap fiber may be constructed using the methods of the present invention. In the embodiment of FIG. 5, the sacrificial rods include a core sacrificial rod 90 and a set of photonic band gap sacrificial rods 92. The sacrificial rods are held in a desired arrangement by a holding apparatus (not shown). One of the methods described above is used to form a structured material around the outside surfaces of the sacrificial rods 90 and 92. For example, vapor axial deposition may be used to form a soot 94 around the outside surfaces of the sacrificial rods; and the soot may be sintered to yield structured body 96. After removal of the sacrificial rods, the structured body 96 may be redrawn, etched, and overclad as described above to yield preform 98.

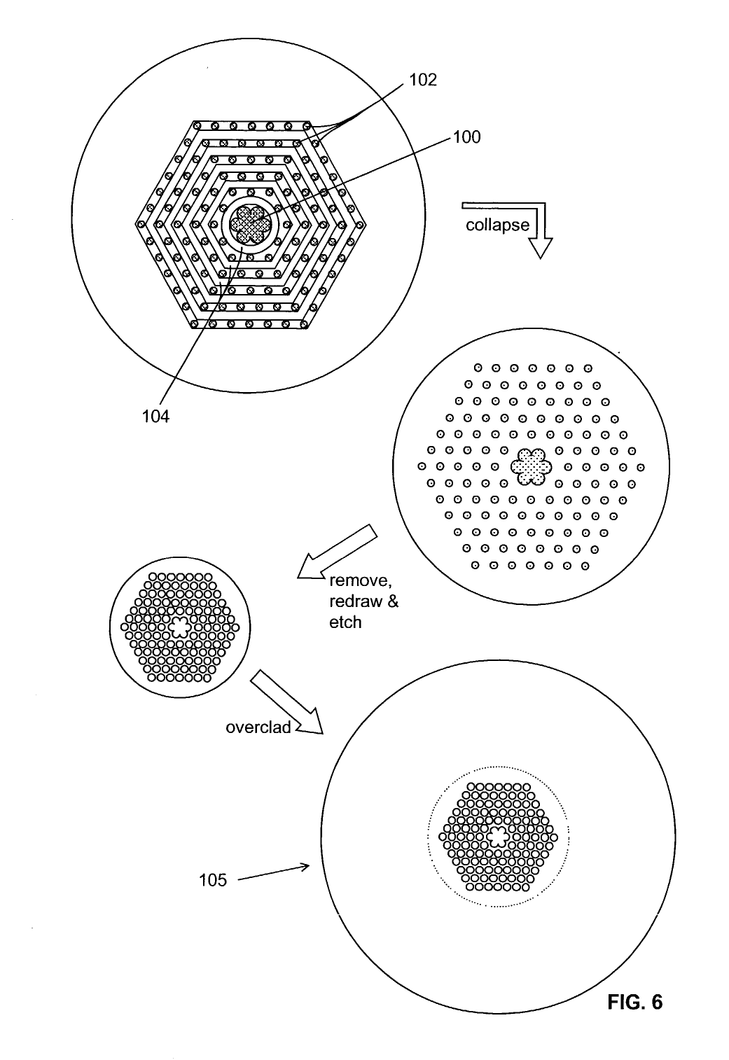

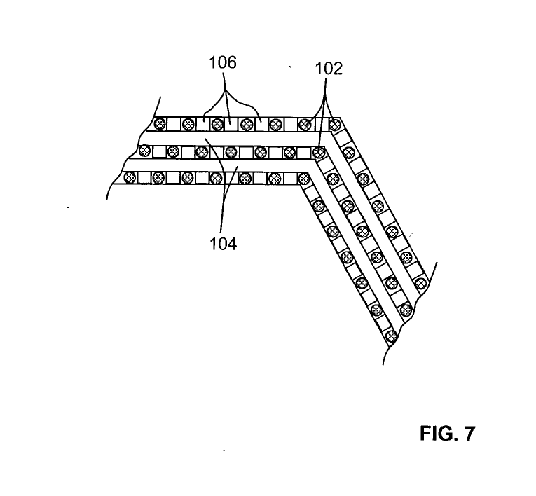

In another embodiment of the present invention, shown in cross-section FIG. 6, a tube collapse method analogous to that of FIGS. 3 and 4 is used to fabricate a photonic band gap fiber preform. Core sacrificial rod 100 and a set of photonic band gap sacrificial rods 102 are provided, and held in place by a holding apparatus (not shown). Tubes 104 of a material suitable for use in the structured body are arranged concentrically in the annular spaces between adjacent rings of sacrificial rods 100 and 102. As shown in partial view in FIG. 7, interstitial rods 106 may be provided in the spaces between the photonic band gap sacrificial rods 102 of a single ring. As described above in connection with FIGS. 3 and 4, a vacuum is applied to the volume between the tubes 104, and the tube/rod assembly is heated to collapse the material around the sacrificial rods 102 and 104, thereby forming structured body 105. The structured body may be included in a preform by overcladding or sleeving as described above.

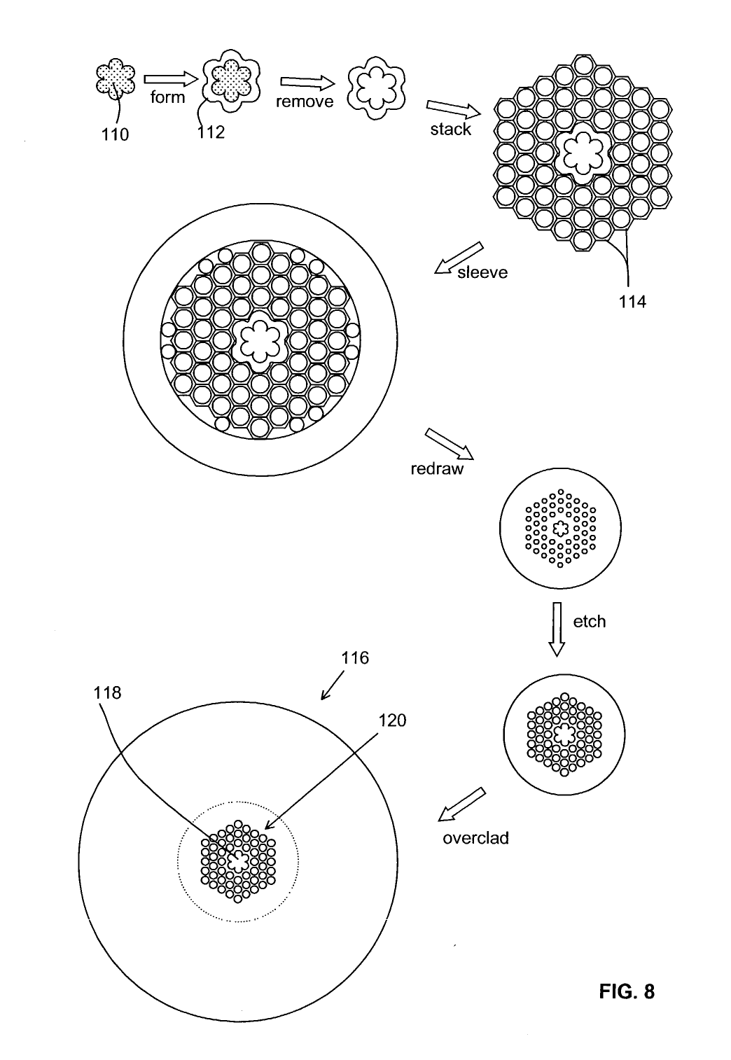

Another exemplary embodiment of the present invention is illustrated in cross-sectional view in FIG. 8. In this embodiment of the invention, the use of conventional stack-and-draw methodologies is combined with the use of one or more sacrificial rods to provide a structured optical fiber preform. A core sacrificial rod 110 is prepared. The core sacrificial rod 110 has a desired cross-sectional shape for the core of a photonic band gap fiber (e.g. the illustrated 6-lobed shape). Using one of the above-described methods, a desired thickness of a material is formed on the outside surface of the core sacrificial rod, forming a structured body 112. For example, the sacrificial rod may be coated with a silica soot, which is consolidated to yield the structured body 112. The sacrificial rod 110 is removed from the structured body, and the structured body 112 is used as a core tube in a conventional stack-and-draw process. For example, the structured body 112 is bundled with a plurality of hexagonal-sided hollow tubes 114, sleeved, redrawn and overclad to form a photonic band gap fiber preform 116 having a core defect 118 and a photonic band gap structure 120. The use of the sacrificial rod 110 to define the shape of the core defect 118 allows for a wide variety of core defect geometries to be achieved in an otherwise conventional stack-and-draw process.

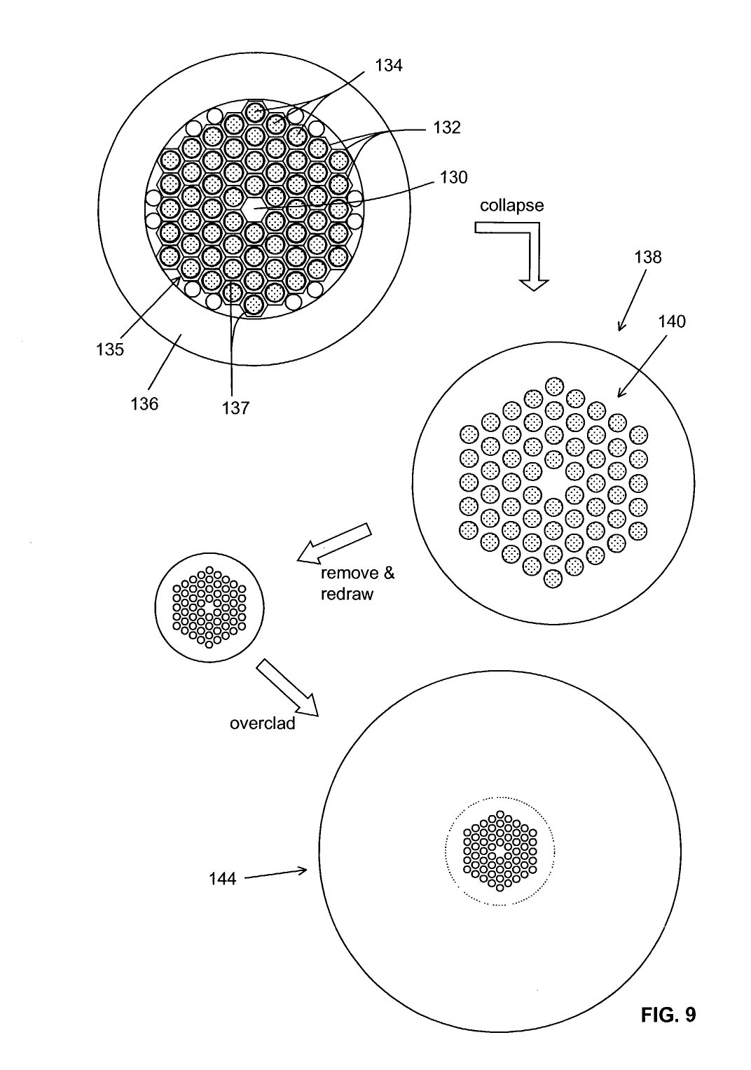

In another embodiment of the present invention, a conventional stack-and-draw method is modified to include sacrificial rods in the holes of the hollow tubes. This embodiment of the invention is shown in cross-sectional view in FIG. 9. A core member 130 is provided. The core member 130 may be, for example, a core rod (as shown in FIG. 9), a structured core tube, a sacrificial rod surrounded by a core tube, or a core body including a structured core material in contact with a sacrificial rod. A plurality of hexagonal-sided hollow tubes 132 (made of, for example, fluorine-doped silica) is provided, and a sacrificial rod 134 is inserted into each of the tubes 132. The tubes 132 are arranged around the core member to form a bundle 135, which is inserted into a sleeve tube 136. The bundle includes voids 137, formed, for example, at the interfaces between adjacent tubes 132, and at the interfaces between the inner surface of each tube 132 and its corresponding sacrificial rod 134. A vacuum is applied to the inside of the sleeve tube 136, and the sleeved bundle is heated to collapse any voids, thereby forming structured body 138 having a photonic band gap structure 140. The step of heating the sleeved bundle may be performed without concern for collapse of the structural elements of the body, as their shapes remain fixed by the sacrificial rods. As such, the heating conditions may be chosen to guarantee complete collapse of the voids of the bundle. As shown in FIG. 9, if the bundle 135 has relatively little void volume, the pitch of the photonic band gap structure 140 will be determined by the arrangement of the tubes 132. The diameter of the individual structures of the photonic band gap structure 140 will be determined, as described above, by the diameter of the sacrificial rods 132. The sacrificial rods 132 may be removed from the structured body as described above (e.g. by burning out), and the structured body may be redrawn and overclad, (with boron-doped silica, for example) to yield preform 144.

In the embodiment described in connection with FIG. 9, the sacrificial rods 132 are not held in a holding apparatus; rather, the spacing of the tubes 132 defines the spacing of the structural elements of the structured body 138. As the skilled artisan will appreciate, the method may be performed with the sacrificial rods 132 held in a fixed spatial relationship by a holding apparatus in order to guarantee the desired structural arrangement.

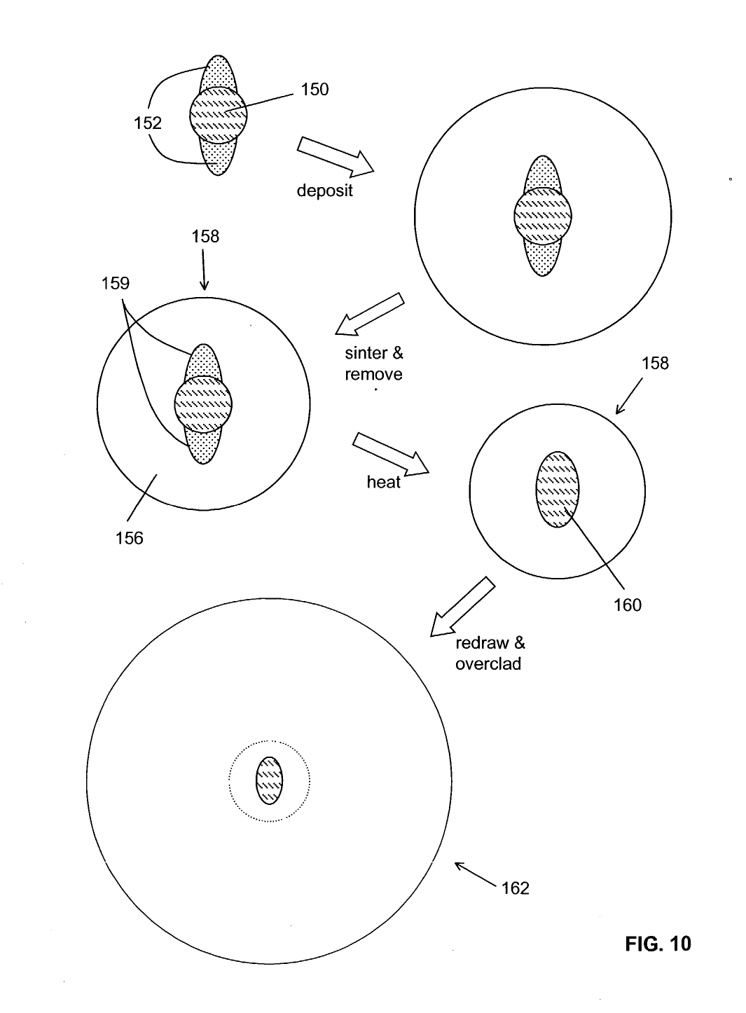

In another embodiment of the invention, the structured body is heated to allow the core material to flow into the voids vacated by the removal of the sacrificial rods. An exemplary method according to this embodiment of the invention is illustrated in cross-sectional view in FIG. 10. A core rod 150 is held between two opposing sacrificial rods 152 by a holding apparatus (not shown). The sacrificial rods may be shaped to give the core rod/sacrificial rods assembly a generally elliptical shape. A cladding material 156 is formed around the outside surface of the core rod/sacrificial rods assembly, forming structured body 158. Any of the methods described hereinabove is used to form the cladding material 156. For example, as shown, a soot may be deposited on the assembly, then consolidated to form the cladding material 156. Alternatively, a cladding tube may be placed around the outside of the assembly, and collapsed using heat and vacuum to form the cladding material 156. The sacrificial rods are removed from the structured body, forming voids 159, and the structured body is further consolidated under conditions that allow the cladding material 156 and material from the core rod 150 to flow into the voids 159. In this further consolidation process, flow of material from the core rod into the voids serves to form a substantially anisotropically-shaped core 160 in the structured body 158. The structured body may be overclad to form a preform 162 using methods familiar to the skilled artisan. The preform 162 fabricated using the method of this embodiment of the invention is suitable for the fabrication of an polarization maintaining fiber.

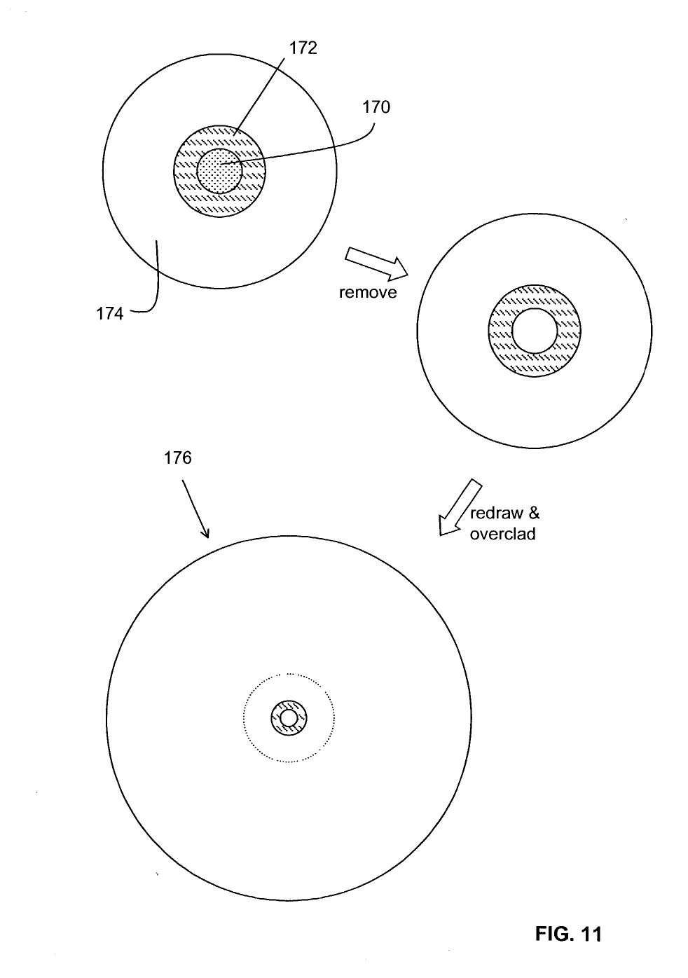

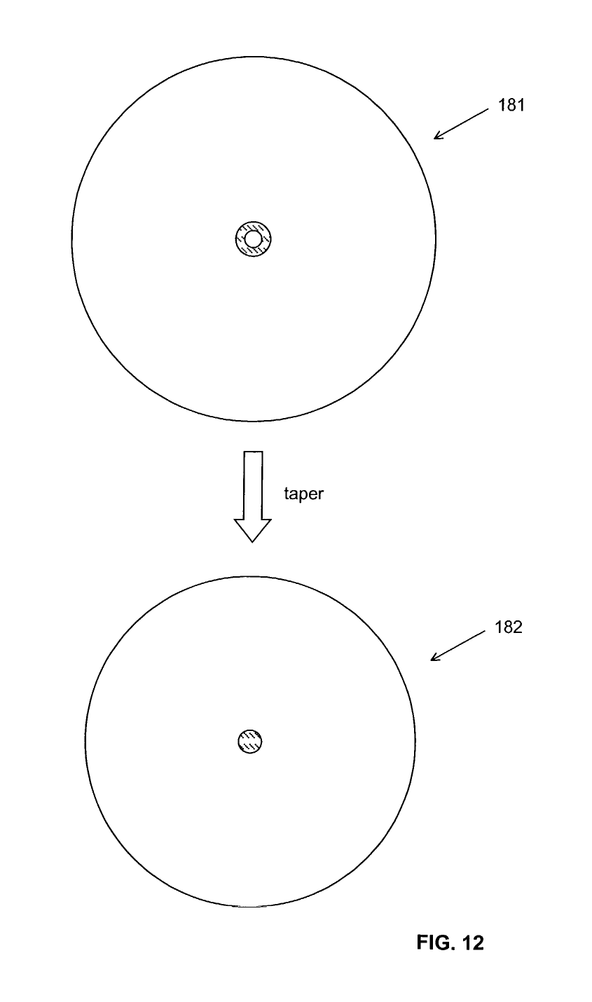

In another embodiment of the invention, a single sacrificial rod is used to provide a single structural element in an optical fiber preform. FIG. 11 is a cross-sectional view of a method for making a mode-converter fiber. A layer 172 of high-index material suitable for the core of an optical fiber, and a layer 174 of low-index material suitable for an optical fiber cladding are deposited on a single cylindrical sacrificial rod 170, forming structured body 174. Desirable core/cladding material combinations include germanium-doped silica/undoped silica and silica/fluorine-doped silica. The sacrificial rod 170 is removed, and structured body 174 is redrawn and overclad to form preform 176. The preform may be drawn into mode converter fiber, shown in FIG. 12. The mode converter fiber 181 of FIG. 12 has an annular-shaped core 182 surrounding a structural void 180. The annular-shaped core is designed to support only the LP₀₂ mode for an optical signal of a desired wavelength. A section of mode converter fiber can be tapered by the skilled artisan to yield tapered fiber section 182, which is single mode at the desired wavelength. The tapered section can serve as an adiabatic mode converter between the LP₀₂ mode in untapered fiber 181 and the LP₀₁ mode in tapered fiber section 182.

It may be desirable to form the preform so that the material of an inner portion of the preform has a higher softening point than the material of an outer portion of the preform, as is described in commonly owned U.S. patent application Ser. No. 10/171,337, filed on Jun. 12, 2002 and entitled “MICROSTRUCTURED OPTICAL FIBERS AND METHODS AND PREFORMS FOR FABRICATING MICROSTRUCTURED OPTICAL FIBERS”, which is incorporated herein by reference. For example, the difference in softening points may be about 50° C. or greater, about 100° C. or greater, or even about 150° C. or greater. One way to achieve such a difference is to use silica glass to form the structured body, and a fluorine-doped silica tube as the sleeve. In cases where a specially-shaped core structure is used, it may be desirable to form the core structure from a material with an even higher softening point (e.g. tantalum-doped silica). Such a difference in softening point allows the inner portion of the preform to be at a somewhat higher viscosity during the draw, leading to less distortion of the inner portion of the structure.

The structured optical fiber preforms of the present invention may be made using other methods familiar to the skilled artisan. For example, redraw techniques may be used to reduce the preform diameter. Etching with SF₆, NF₃ or aqueous NH₄F·HF may be used to enlarge the size of the holes. Redraw and etching procedures are described, for example, in U.S. patent application Ser. No. 09/563,390, which is incorporated herein by reference.

Another aspect of the present invention includes a method of making an optical fiber preform by depositing a soot onto a framework of elongated elements. The method includes the step of providing a plurality of elongate elements, each elongate element having an outside surface, the elongate elements being held in a fixed spatial relationship; forming a soot on the outside surface of each elongate element, thereby substantially filling the spaces between the elongate elements to form a structured body; consolidating the soot; and including the structured body in the optical fiber preform.

In one embodiment of the invention, the elongate elements are sacrificial rods which are eventually removed from the structured body, for example as described above in connection with FIGS. 1 and 5. In other embodiments of the invention, the elongate elements may be solid rods or hollow tubes which remain in the structured body and become part of the eventual preform. Vapor axial deposition is an especially suitable method for use in forming the soot on the outside surfaces of the elongate elements, especially in cases when there are a large number of elongate elements. However, other methods, such as OVD and soot casting, can be used to form the soot.

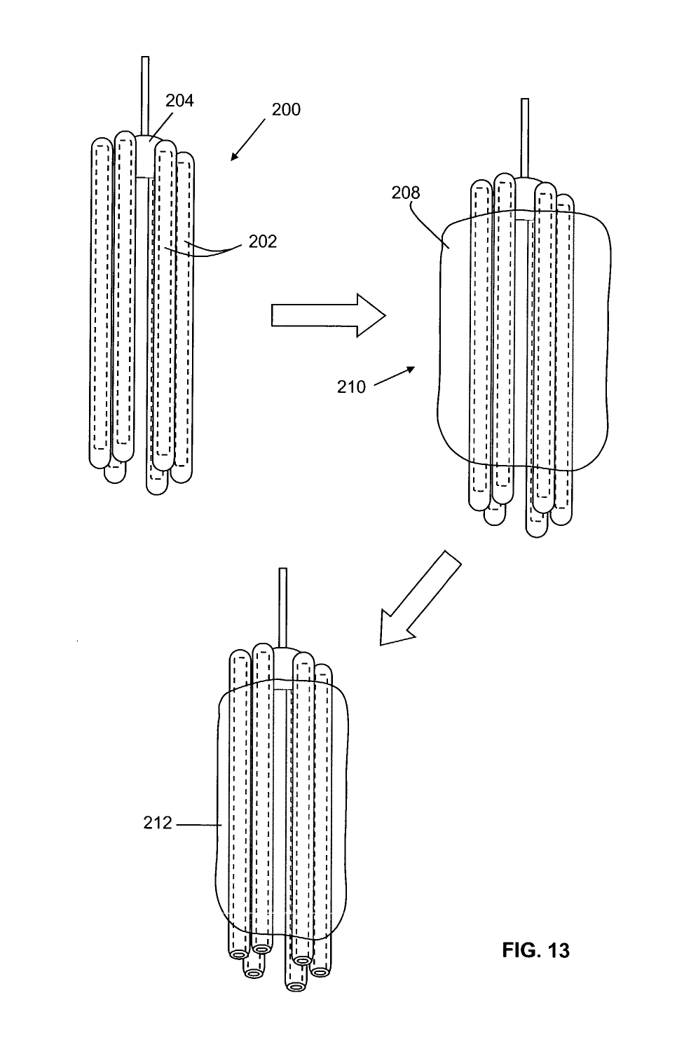

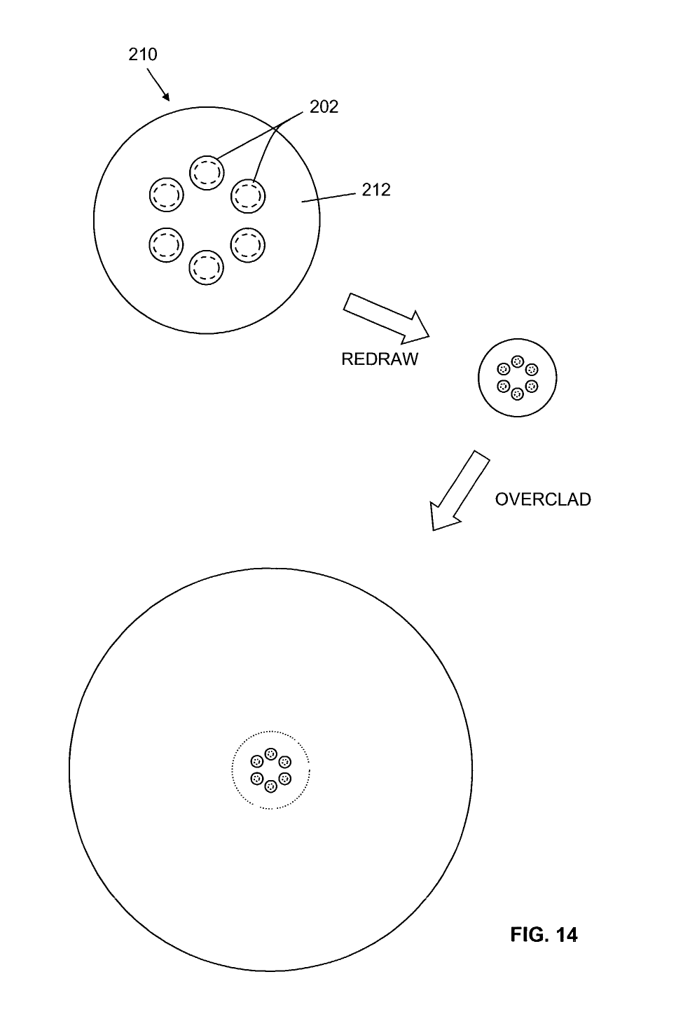

An example of a method of fabricating an optical fiber preform according to one embodiment of the present invention is shown in FIGS. 13 and 14. A framework 200 of elongate optical elements 202 is provided. The elongate optical elements are held in a fixed spatial relationship by being fused at one end to a glass hemisphere 204. In the embodiment of FIGS. 13 and 14, the elongate elements 202 are hollow glass tubes. The interiors of the hollow glass tubes define the holes of the structure. The hollow glass tubes are sealed shut at both ends to avoid the deposition of soot on their interior surfaces. A vapor axial deposition (VAD) lathe is used to deposit a soot 208 on the outside surfaces of the elongate elements, filling the spaces therebetween, thereby forming a structured body 210. The soot may be of a material that is substantially the same, or somewhat different than the material of the glass tubes. For example, the glass tubes may be formed from germanium-doped silica, while the soot is of substantially undoped silica. Such a combination of materials may be useful in the fabrication of the photonic crystal fibers described in U.S. Pat. No. 6,334,017, which is incorporated herein by reference. The glass tubes are opened up on one side, and the soot is consolidated to form structured material 212. The body 210 is included in an optical fiber preform by, for example, redrawing and overcladding the body, as shown in cross-sectional view in FIG. 14. As the skilled artisan will appreciate, solid rods may also be used as the elongate elements in the above-described method. For example, solid glass rods of higher index may be used to form some of the photonic crystal fibers described in U.S. Pat. No. 6,334,017.

Another aspect of the invention includes a method for drawing an optical fiber. The method includes the step of drawing a preform fabricated as described hereinabove into optical fiber. For example, in one embodiment of the present invention, a method for drawing optical fiber includes the steps of providing at least one sacrificial rod having an outside surface; forming a material on the outside surface of each sacrificial rod to yield a structured body, the structured body including a structured material in substantial contact with the at least one sacrificial rod; removing each sacrificial rod from the structured body; including the structured body in the optical fiber preform; and drawing the preform into an optical fiber. In another embodiment of the present invention, a method for drawing an optical fiber includes the steps of providing a plurality of elongate elements, each elongate element having an outside surface, the elongate elements being held in a fixed spatial relationship; forming a soot on the outside surface of each elongate element, substantially filling the spaces between the elongate elements to form a structured body; consolidating the soot; including the structured body in the optical fiber preform; and drawing the optical fiber preform into the optical fiber.

The structured optical fiber preforms may be drawn into microstructured optical fiber using methods familiar to the skilled artisan. A pressure may be placed on the holes of the preform during the draw in order to keep them from closing due to surface tension. It may be desirable to place different pressures on different sets of holes of the preform, as is described in commonly owned U.S. patent application Ser. No. 10/171,335, filed Jun. 12, 2002 and entitled “METHODS AND PREFORMS FOR DRAWING MICROSTRUCTURED OPTICAL FIBERS”, which is incorporated herein by reference. For example, the large core hole of a photonic band gap fiber may be coupled to a first pressure system, and the holes of the photonic crystal structure may be coupled to a second pressure system. The first pressure system may be set to a lower pressure than the second pressure system so that the inner core hole does not expand relative to the holes of the photonic crystal structure.

Another aspect of the present invention includes an optical fiber made by the methods described hereinabove. For example, one embodiment of the invention is an optical fiber made by a method including the steps of providing at least one sacrificial rod having an outside surface; forming a material on the outside surface of each sacrificial rod to yield a structured body, the structured body including a structured material in substantial contact with the at least one sacrificial rod; removing each sacrificial rod from the structured body; including the structured body in the optical fiber preform; and drawing the preform into an optical fiber. Another embodiment of the invention includes an optical fiber made by a method including the steps of providing a plurality of elongate elements, each elongate element having an outside surface, the elongate elements being held in a fixed spatial relationship; forming a soot on the outside surface of each elongate element, substantially filling the spaces between the elongate elements to form a structured body; consolidating the soot; including the structured body in the optical fiber preform; and drawing the optical fiber preform into the optical fiber.

Another aspect of the invention includes an optical communications system including an optical fiber made by the methods described hereinabove. For example, one embodiment of the invention is an optical communications system including an optical fiber made by a method including the steps of providing at least one sacrificial rod having an outside surface; forming a material on the outside surface of each sacrificial rod to yield a structured body, the structured body including a structured material in substantial contact with the at least one sacrificial rod; removing each sacrificial rod from the structured body; including the structured body in the optical fiber preform; and drawing the preform into an optical fiber. Another embodiment of the invention includes an optical communications system including an optical fiber made by a method including the steps of providing a plurality of elongate elements, each elongate element having an outside surface, the elongate elements being held in a fixed spatial relationship; forming a soot on the outside surface of each elongate element, substantially filling the spaces between the elongate elements to form a structured body; consolidating the soot; including the structured body in the optical fiber preform; and drawing the optical fiber preform into the optical fiber.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. A method of making an optical fiber preform having a core region and a cladding region, the method comprising the steps of
providing at least one sacrificial rod having an outside surface;
forming a material on the outside surface of each sacrificial rod to yield a structured body, the structured body including a structured material in substantial contact with the at least one sacrificial rod;
removing each sacrificial rod from the structured body; and
including the structured body in the optical fiber preform.

2. The method of claim 1 wherein a plurality of sacrificial rods is provided, and wherein the plurality of sacrificial rods is held in a fixed spatial relationship by a holding apparatus.

3. The method of claim 1 wherein the step of forming the material comprises the steps of
forming a soot on the outside surface of each sacrificial rod; and
sintering the soot to form the structured material.

4. The method of claim 3 wherein the step of forming the soot is performed by a technique selected from the group consisting of vapor axial deposition, soot casting, and outside vapor deposition.

5. The method of claim 1 wherein the step of forming the material comprises the steps of
contacting a sol with the outside surface of each sacrificial rod;
allowing the sol to gel; and
firing the gel to form the structured material.

6. The method of claim 5 wherein the step of removing each sacrificial rod is performed before the step of firing the gel.

7. The method of claim 1 wherein the step of forming the material includes the steps of
contacting a melted material with the outside surface of each sacrificial rod; and
allowing the melted material to cool, thereby forming the structured material.

8. The method of claim 1 wherein the step of forming the material comprises the step of
depositing a material on the surface of the sacrificial rod to form the structured material.

9. The method of claim 1 wherein the step of providing the at least one sacrificial rod includes the step of
placing a tube of a material around one or more of the sacrificial rods; and
wherein the step of forming the material includes the step of
collapsing the tube around the one or more sacrificial rods to form the body.

10. The method of claim 1 wherein the step of including the body in a structured optical fiber preform includes the step of overcladding the body with an overclad material.

11. The method of claim 10 wherein the overclad material has a softening point that is at least about 50° C. less than the softening point of the structured material.

12. The method of claim 1 wherein the step of including the body in an optical fiber preform includes the step of bundling the body with a plurality of tubes to form a bundle.

13. The method of claim 12 wherein the step of including the body in an optical fiber preform further includes the step of redrawing the bundle to yield the preform.

14. The method of claim 12 wherein the body forms the core region of the optical fiber preform and wherein the plurality of tubes form the cladding region of the optical fiber preform.

15. The method of claim 1 wherein the step of providing at least one sacrificial rod includes the steps of
providing a core rod formed from a core material; and
arranging a plurality of sacrificial rods around the core rod.

16. The method of claim 15 wherein the method further includes, after the step of forming the material, the step of
heating the body to allow the core material and the structured material to flow and fill any voids in the body.

17. The method of claim 15 wherein the method further includes, after the step of removing the sacrificial rods, the step of heating the body to allow the core material to flow and fill the voids vacated by the removal of the sacrificial rods.

18. The method of claim 17 wherein the plurality of sacrificial rods include two sacrificial rods arranged on opposing sides of the core rod, and wherein the optical fiber has a substantially elliptical core.

19. The method of claim 1 wherein the step of providing at least one sacrificial rod includes the steps of
providing a plurality of sacrificial rods;
inserting each sacrificial rod into a tube; and
arranging the tubes around a core member,
wherein the step of forming the material includes the step of
collapsing the tubes to form the body.

20. The method of claim 19 wherein the core member is selected from the group consisting of a core rod, a structured core tube, a sacrificial rod surrounded by a core tube, and a core body including a structured core material in contact with a sacrificial rod.

21. The method of claim 1 wherein the sacrificial rod has an acircular cross-section.

22. The method of claim 1 wherein the sacrificial rod is formed from graphite.

23. The method of claim 1 wherein the step of removing each sacrificial rod includes a physical removal of each rod.

24. The method of claim 1 wherein the step of removing each sacrificial rod includes a chemical removal of each rod.

25. The method of claim 1 wherein the microstructured body has a circularly asymmetric cross-sectional arrangement of structures.

26. A method of making an optical fiber comprising the steps of:
fabricating an optical fiber preform according to the method of claim 1; and
drawing the optical fiber preform into the optical fiber.

27. An optical fiber fabricated according to the method of claim 26.

28. An optical communications system including an optical fiber fabricated according to the method of claim 26.

29. A method of making an optical fiber preform having a core region and a cladding region, the method comprising the steps of
providing a plurality of elongate elements, each elongate element having an outside surface, the elongate elements being held in a fixed spatial relationship;
forming a soot on the outside surface of each elongate element, substantially filling the spaces between the elongate elements to form a structured body;
consolidating the soot to form a structured material; and
including the structured body in the optical fiber preform.

30. The method of claim 29 wherein the soot is deposited using vapor axial deposition.

31. The method of claim 29 wherein the plurality of elongate elements includes at least one sacrificial rod, the method further comprising the step of removing each sacrificial rod from the structured body.

32. The method of claim 29 wherein the plurality of elongate elements includes at least one hollow tube, and wherein the at least one hollow tube becomes part of the structured body.

33. The method of claim 29 wherein the plurality of elongate elements includes at least one solid rod, and wherein the at least one solid rod becomes part of the structured body.

34. The method of claim 29 wherein the soot is formed from a siliceous material.
